(19) United States
(12) Patent Application Publication
(10) Pub. No.: US 2025/0073664 A1
(43) Pub. Date: Mar. 6, 2025

(54) REACTOR

(71) Applicant: Honda Motor Co., Ltd., Tokyo (JP)

(72) Inventor: Yoshikazu Yamada, Wako-shi (JP)

(21) Appl. No.: 18/809,304

(22) Filed: Aug. 19, 2024

(30) Foreign Application Priority Data
Sep. 1, 2023 (JP) 2023-142252

(51) Int. Cl. B01J 19/24

(52) U.S. Cl. CPC B01J 19/248; B01J 2204/007; B01J 2219/2401

(57) ABSTRACT

Reactor includes: first-flow-passage formed in band-shape to extend in length-direction and width-direction and in spiral-shape centered on vertical-axis parallel to width-direction and having open upper-end-surface; second-flow-passage formed in spiral-shape to be radially arranged alternately with first-flow-passage on vertical-cross-section including vertical-axis and having open upper-end-surface to communicate with upper-end-surface of first-flow-passage; reaction-liquid-supplying-flow-passage through which reaction-liquid is supplied to supplying-portion provided at lower-end of maximum-outer-diameter-portion of first-flow-passage; reaction-liquid-discharging-flow-passage through which reaction-liquid is discharged from discharging-portion provided at maximum-outer-diameter-portion of second-flow-passage; and return-flow-passage connecting first-connecting-portion provided at lower-end of maximum-outer-diameter-portion of first-flow-passage and second-connecting-portion provided at maximum-outer-diameter-portion of second-flow-passage. Height of upper-end-surface of first-flow-passage and height of upper-end-surface of second-flow-passage are substantially same as each other all over in radial direction. Lower-end-surface of second-flow-passage is positioned above lower-end-surface of first-flow-passage all over in radial direction and is formed to be inclined downward toward radial outer side.

### CROSS-REFERENCE TO RELATED APPLICATION

This application is based upon and claims the benefit of priority from Japanese Patent Application No. 2023-142252 filed on Sep. 1, 2023, the content of which is incorporated herein by reference.

### BACKGROUND OF THE INVENTION

### Field of the Invention

The present invention relates to a reactor.

### Description of the Related Art

In the related art, reactors configured to reform fuel are known. A reactor described in JP 2022-112890 A is configured as a double-pipe reactor having a reaction field between an outer pipe member and an inner pipe member, which are provided coaxially, and circulates a heat carrier through the side at the inner circumference of the inner pipe member and circulates fuel through the reaction field to be reformed.

In this type of reactor, it is necessary to increase the volume of the reaction field in order to increase the amount of the reformed fuel generated. However, in the double-pipe reactor described in JP 2022-112890 A, in order to increase the volume of the reaction field, the total length becomes longer proportionally, and it is difficult to efficiently increase the volume of the reaction field.

### SUMMARY OF THE INVENTION

An aspect of the present invention is a reactor, including: a first flow passage formed in a band shape to extend in a length direction and a width direction and formed in a spiral shape centered on a vertical axis parallel to the width direction and having an open upper end surface; a second flow passage formed in a spiral shape centered on the vertical axis to be radially arranged alternately with the first flow passage on a vertical cross section including the vertical axis and having an open upper end surface to communicate with the upper end surface of the first flow passage; a reaction liquid supplying flow passage through which reaction liquid is supplied to a supplying portion provided at a lower end of a maximum outer diameter portion of the first flow passage centered on the vertical axis; a reaction liquid discharging flow passage through which the reaction liquid is discharged from a discharging portion provided at a maximum outer diameter portion of the second flow passage centered on the vertical axis; and a return flow passage connecting a first connecting portion provided at the lower end of the maximum outer diameter portion of the first flow passage and a second connecting portion provided at the maximum outer diameter portion of the second flow passage. A height of the upper end surface of the first flow passage and a height of the upper end surface of the second flow passage are substantially same as each other all over in a radial direction centered on the vertical axis. A lower end surface of the second flow passage is positioned above a lower end surface of the first flow passage all over in the radial direction and is formed to be inclined downward toward a radial outer side centered on the vertical axis.

### BRIEF DESCRIPTION OF THE DRAWINGS

The objects, features, and advantages of the present invention will become clearer from the following description of embodiments in relation to the attached drawings, in which:

FIG. 1 is an assembled perspective view illustrating a partially cut-out reactor according to an embodiment of the present invention;

FIG. 2 is a cross-sectional view of the reactor taken along line II-II in FIG. 1;

FIG. 3 is a cross-sectional view of the reactor taken along line III-III in FIG. 2;

FIG. 4 is a cross-sectional view of the reactor taken along line IV-IV in FIG. 2;

FIG. 5 is a view for describing a reaction flow passage in FIG. 1;

FIG. 6 is a view for describing a heat carrier flow passage in FIG. 1;

FIG. 7 is a view for describing a heat carrier discharging flow passage in FIG. 1;

FIG. 8 is a cross-sectional view of the reactor taken along line VIII-VIII in FIG. 1;

FIG. 9 is a cross-sectional view of the reactor taken along line IX-IX in FIG. 1;

FIG. 10 is a view for describing the downward flow passage in FIG. 1; and

FIG. 11 is a view for describing a modification example of the reactor in FIG. 1.

### DETAILED DESCRIPTION OF THE INVENTION

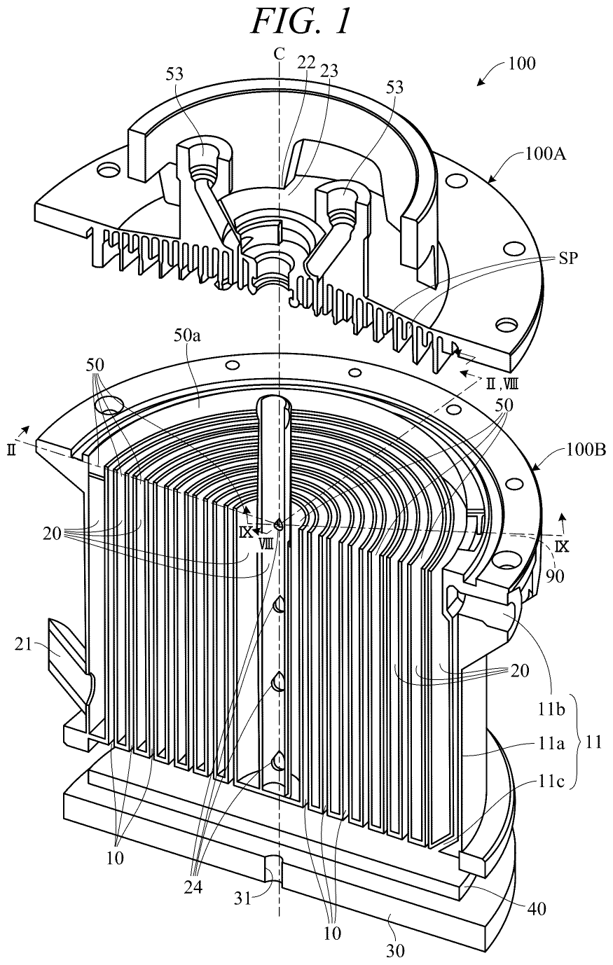

Hereinafter, embodiments of the present invention will be described with reference to FIGS. 1 to 11. A reactor according to the embodiments of the present invention is a flow reactor in which a reaction liquid is circulated to perform a reaction. Hereinafter, in particular, a reforming reactor that is applied to a compression ignition engine mounted to a vehicle and reforms fuel supplied from a fuel tank to the engine by causing an oxidation reaction of the fuel will be described.

The average global temperature is maintained in a warm state suitable for living things by greenhouse gases in the atmosphere. To be specific, heat radiated from the ground surface that has been heated by sunlight to outer space is partially absorbed by the greenhouse gases, and is re-radiated to the ground surface, and the atmosphere is maintained in a warm state. Increasing concentrations of greenhouse gases in the atmosphere cause an increase in average global temperature (global warming). Carbon dioxide is a greenhouse gas that greatly contributes to global warming, and its concentration in the atmosphere depends on the balance between carbon fixed on or in the ground in the form of plants or fossil fuels and carbon present in the atmosphere in the form of carbon dioxide. For example, the carbon dioxide in the atmosphere is absorbed through photosynthesis in the growth process of plants, causing a decrease in carbon dioxide concentration in the atmosphere. The carbon dioxide is also released into the atmosphere through combustion of fossil fuels, causing an increase in the carbon dioxide concentration in the atmosphere. In order to mitigate global warming, it is necessary to reduce carbon emissions by replacing fossil fuels with a renewable energy source such as sunlight or wind power, or renewable fuel derived from biomass.

As such a renewable fuel, low-octane gasoline obtained by Fischer-Tropsch (FT) synthesis is becoming widespread. Low-octane gasoline has high ignitability and can be applied to a compression ignition engine. However, low-octane gasoline is still in the stage of becoming widespread and is not yet sold in some areas. On the other hand, regular octane gasoline for a spark ignition engine, which is currently widespread, has low ignitability, and cannot be applied to a compression ignition engine as it is.

By placing a reforming reactor in a fuel supply path from a fuel tank to an injector of an engine and reforming the fuel as necessary, both low-octane gasoline and regular octane gasoline can be compression-ignited in a single engine. Thus, in this embodiment, the reactor is configured as below such that mountability to the vehicle can be improved by efficiently increasing the volume of the reaction field.

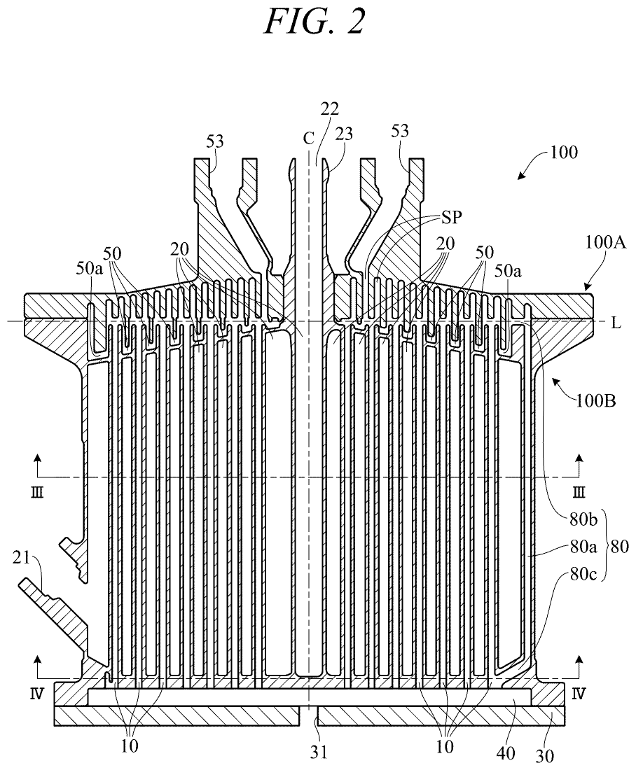

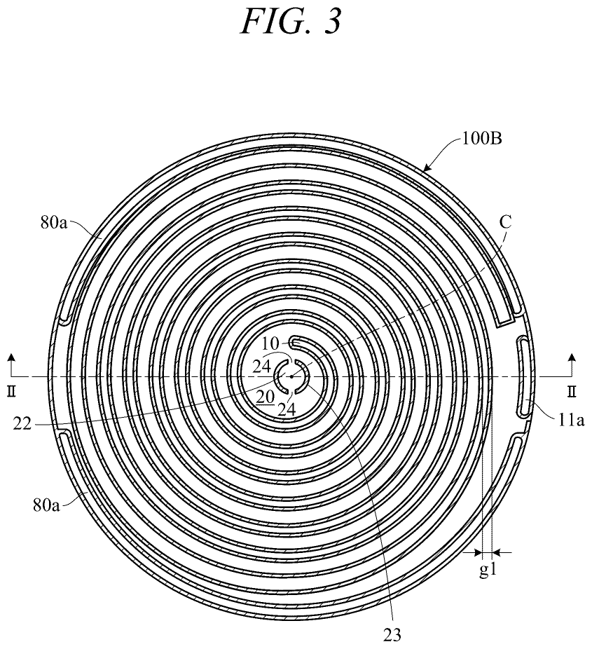

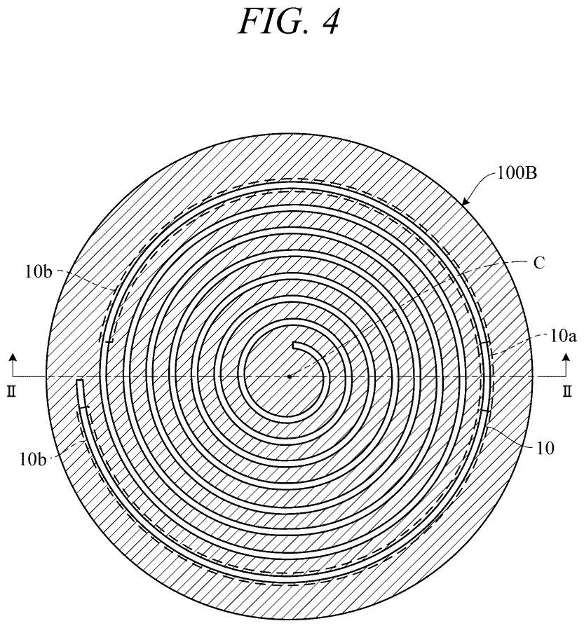

FIG. 1 is an assembled perspective view illustrating a partially cut-out reactor 100 according to an embodiment of the present invention. FIG. 2 is a cross-sectional view of the reactor 100 taken along line II-II in FIG. 1. FIG. 3 is a cross-sectional view of the reactor 100 taken along line III-III in FIG. 2. FIG. 4 is a cross-sectional view of the reactor 100 taken along line IV-IV in FIG. 2. Hereinafter, a direction radially extending from a vertical axis C is defined as a radial direction, and a direction along a circumference of a circle centered on the vertical axis C is defined as a circumferential direction.

As illustrated in FIG. 1, the reactor 100 has an upper piece 100A and a lower piece 100B formed using a metal material having high thermal conductivity. For example, in a case where the reactor 100 is formed by additive manufacturing (AM) or the like, a partition wall or the like separating flow passages can be thinned, and the entire reactor 100 can be reduced in size. As illustrated in FIGS. 1 and 2, the upper piece 100A and the lower piece 100B are configured to be detachably attached to each other via a seal ring (not illustrated) with a bolt and a nut (not illustrated). Consequently, maintainability of the inside of the reactor 100 is improved.

In the lower piece 100B of the reactor 100, a reaction flow passage 10 through which fuel as a reaction liquid circulates and a heat carrier flow passage 20 through which a heat carrier circulates are formed. As illustrated in FIGS. 1 to 4, the reaction flow passage 10 and the heat carrier flow passage 20 are configured to have a band shape to extend in a width direction parallel to the vertical axis C and a length direction perpendicular to the width direction, respectively, and are configured to have a helical or spiral shape centered on the vertical axis C, and are alternately arranged in the radial direction. By making the reactor 100 helical or spiral, the volume of the reaction field can be efficiently increased.

As illustrated in FIGS. 1 and 2, an upper end surface and a lower end surface of the reaction flow passage 10 are open, and an upper end surface and a lower end surface of the heat carrier flow passage 20 are closed. A bottom surface of the reactor 100 (lower piece 100B) in which the reaction flow passage 10 and the heat carrier flow passage 20 are formed is closed by a closing plate 30. The closing plate 30 is provided with an opening 31, and air (gas) is supplied from an air pump (not illustrated) to the reactor 100 (the reaction flow passage 10) via the opening 31. A check valve is provided in the air supply passage from the air pump to the opening 31, and the outflow of the fuel through the opening 31 is prevented.

A filter 40 made of a metal fine-pore mesh material or a porous material such as a sintered body or a foam and having homogeneous pores is interposed between the lower end surface of the reaction flow passage 10 (and the heat carrier flow passage 20) and the closing plate 30. The fuel circulating in the reaction flow passage 10 also fills a space between the lower piece 100B and the closing plate 30 of the reactor 100 including the filter 40.

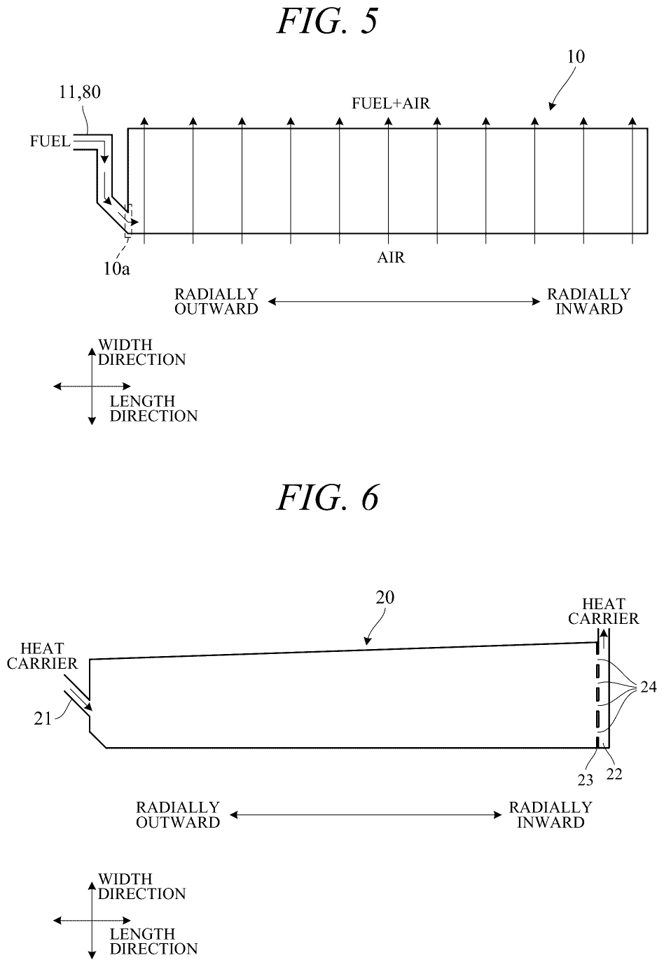

FIG. 5 is a view for describing the reaction flow passage 10. As illustrated in FIGS. 1, 2, and 5, a height of the upper end surface of the reaction flow passage 10 is uniform all over in the radial direction. As illustrated in FIGS. 1 and 5, in the lower piece 100B of the reactor 100, further, a reaction liquid supplying flow passage 11 for supplying the unreformed fuel to a supplying portion 10a (FIG. 4) provided at the lower end of the maximum outer diameter portion of the reaction flow passage 10 is formed. As illustrated in FIG. 1, the reaction liquid supplying flow passage 11 includes a vertical flow passage 11a, a horizontal flow passage 11b, and an inclined flow passage 11c.

The vertical flow passage 11a extends in a vertical direction from the vicinity of an upper end to the vicinity of a lower end of the lower piece 100B on a side further outward from the maximum outer diameter portions of the reaction flow passage 10 and the heat carrier flow passage 20. The horizontal flow passage 11b extends in a horizontal direction to allow an upper end of the vertical flow passage 11a to communicate with the external space. The inclined flow passage 11c extends to be inclined downward toward the radial inner side to allow a lower end of the vertical flow passage 11a to communicate with the supplying portion 10a of the reaction flow passage 10. In other words, a lower end surface of the reaction liquid supplying flow passage 11 is formed to be inclined downward toward the radial inner side.

Consequently, unreformed fuel is supplied to the reaction flow passage 10 from a fuel tank (not illustrated) via the reaction liquid supplying flow passage 11. The fuel supplied from above via the reaction liquid supplying flow passage 11 including the vertical flow passage 11a and the inclined flow passage 11c flows radially inward in the length direction of the reaction flow passage 10 and flows upward in the width direction together with air supplied from below. Since the lower end surface of the reaction liquid supplying flow passage 11 is formed to be inclined downward toward the radial inner side, the flow of the fuel toward the radial inner side is promoted, and the fuel can be uniformly circulated in the reaction flow passage 10 all over in the radial direction.

The air supplied via the opening 31 of the closing plate 30 passes through the filter 40 to become homogeneous fine bubbles and is supplied to the reaction flow passage 10. Consequently, the fine-bubble-shaped air (bubbles) is supplied to the reaction flow passage 10 from below all over in the radial direction. The bubbles supplied to the reaction flow passage 10 flow to rise in the width direction of the reaction flow passage 10. The air bubbles disappear overtime, but since the length of the reaction flow passage 10 in the width direction is relatively short, for example, the air bubbles can be reliably maintained in a range from the lower end surface to the upper end surface even in case where the air bubbles are relatively large and the period until the air bubbles disappear is short.

A fuel containing hydrocarbons as a main component is oxidatively reformed using a catalyst such as N-hydroxyphthalimide (NHPI) to produce a peroxide, so that ignitability thereof can be improved. Specifically, with NHPI, a hydrogen atom is easily extracted using an oxygen molecule to produce a phthalimide-N-oxyl (PINO) radical. With the PINO radical, a hydrogen atom is extracted from a hydrocarbon (RH) contained in the fuel to produce an alkyl radical (R⁻). The alkyl radical bonds to an oxygen molecule to produce an alkyl peroxy radical (ROO⁻). With the alkyl peroxy radical, a hydrogen atom is extracted from a hydrocarbon contained in the fuel to produce an alkyl hydroperoxide (ROOH), which is a peroxide.

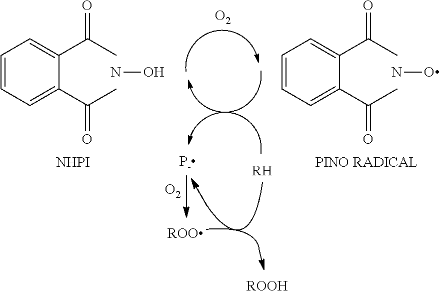

The reaction flow passage 10 functions as a reactor (reaction field) in which the fuel and oxygen in the air react (oxidation reaction, fuel reforming reaction) to generate reformed fuel. In the reaction flow passage 10, a catalyst such as a powdery or wall-supported NHPI catalyst or the like is provided. The fuel supplied to the reaction flow passage 10 is brought into contact with oxygen contained in air (bubbles) supplied from below and the catalyst all over in the radial direction. Consequently, an oxidation reforming reaction of the fuel is promoted all over the reaction flow passage 10 in the radial direction.

In a case where the reactor 100 is formed by additive manufacturing, unevenness can be easily formed on an inner wall surface of the reaction flow passage 10, and a surface area of a wall surface on which the reactant and the catalyst are in contact with each other can be increased. The inner wall surface of the reaction flow passage 10 is plated with a material that does not affect the reforming reaction, such as nickel. The reactor 100 itself may be formed using a material that does not affect the reforming reaction, such as nickel.

Note that, instead of a fixed bed type in which the catalyst is provided in the reaction flow passage 10 through which the reactant flows, a fluidized bed type may be used in which a catalyst solution obtained by mixing a catalyst (powder) with an appropriate solvent is supplied to the reaction flow passage 10 together with the fuel and caused to flow. In this case, the particle size of the catalyst (powder) is reduced, and thus the reaction efficiency can be improved. The NHPI catalyst does not need to be separated from the reformed fuel and can be directly supplied to the engine.

As illustrated in FIG. 3, a gap g1 between inner wall surfaces of the reaction flow passage 10, more specifically, between an inner end surface and an outer end surface of the reaction flow passage 10 in the radial direction, is formed to be equal to or smaller than twice a quenching distance. Consequently, since an inner wall surface of the reaction flow passage 10 is always present in a range within the quenching distance from a reactant, the safety of the reactor 100 can be enhanced. In a case where the safety is further increased, the reactor 100 may be formed such that the gap g1 is equal to or smaller than the maximum safety gap. By configuring the reaction flow passage 10, which is a reaction field in which the oxidation reaction of the fuel proceeds, with the maximum safety gap, for example, the flame is immediately extinguished even in a case where a flame enters from an adjacent device, and thus the safety of the reactor 100 can be further enhanced.

FIG. 6 is a view for describing the heat carrier flow passage 20. As illustrated in FIGS. 1, 2, and 6, the upper end surface of the heat carrier flow passage 20 is formed to be inclined upward toward a radial inner side. Further, in the lower piece 100B of the reactor 100, a heat carrier supplying flow passage 21 for supplying a heat carrier to the vicinity of the lower end of the maximum outer diameter portion of the heat carrier flow passage 20 is formed. The heat carrier supplying flow passage 21 extends to be inclined downward toward the radial inner side to allow the vicinity of the lower end of the maximum outer diameter portion of the heat carrier flow passage 20 to communicate with an external space. In other words, a lower end surface of the heat carrier supplying flow passage 21 is formed to be inclined downward toward the radial inner side.

Engine cooling water as a heat carrier is supplied from an engine (not illustrated) to the heat carrier flow passage 20 via the heat carrier supplying flow passage 21. Since the lower end surface of the heat carrier supplying flow passage 21 is formed to be inclined downward toward the radial inner side, a flow of a heat carrier toward the radial inner side is promoted, and the heat carrier can be uniformly circulated in the heat carrier flow passage 20 all over in the radial direction. Furthermore, as illustrated in FIGS. 1 to 3, the heat carrier flow passage 20 is adjacent to the reaction flow passage 10 via a relatively thin partition wall made of a metal material having high thermal conductivity. When the heat carrier flows through such a heat carrier flow passage 20, even with the heat carrier having a relatively low temperature such as engine cooling water, the temperature of the reaction flow passage 10 functioning as the reaction field of the fuel reforming reaction can be efficiently increased to a catalyst activation temperature range, and the fuel reforming reaction can be suitably promoted.

In a case where the reactor 100 is formed by additive manufacturing, unevenness can be easily formed on an inner wall surface of the heat carrier flow passage 20 (and the reaction flow passage 10), the surface area of the wall surface on which heat exchange is performed can be increased, and heat exchange performance can be improved. The temperature of the reaction flow passage 10 functioning as the reaction field of the fuel reforming reaction is sufficiently increased, and thus the fuel reforming rate can be improved. Alternatively, the number of available catalysts that can be employed can be increased.

As illustrated in FIGS. 1 to 3 and 6, in the lower piece 100B of the reactor 100, further, a heat carrier discharging flow passage 22 for discharging the heat carrier from the inside diameter portion of the heat carrier flow passage 20 is formed. The heat carrier discharging flow passage 22 protrudes upward from a lower end surface of the heat carrier flow passage 20 and is formed in a columnar shape centered on the vertical axis C. The heat carrier flow passage 20 and the heat carrier discharging flow passage 22 provided in the heat carrier flow passage 20 are separated by a cylindrical partition wall 23.

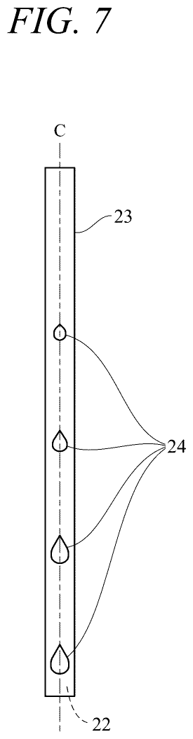

FIG. 7 is a view for describing the heat carrier discharging flow passage 22, and a front view of the partition wall 23. As illustrated in FIGS. 1, 3, 6, and 7, the partition wall 23 is provided with a plurality of (four in the illustrated example) communication holes 24 having different heights from each other from the lower end surface of the heat carrier flow passage 20, and the heat carrier is discharged from the heat carrier flow passage 20 via the communication holes 24 and the heat carrier discharging flow passage 22. The engine cooling water as the heat carrier discharged via the heat carrier discharging flow passage 22 is returned to the engine. The partition wall 23 is formed such that the plurality of communication holes 24 increase in size toward the lower side and decrease in size toward the upper side. Consequently, since the flow of the heat carrier in the heat carrier flow passage 20 becomes greater as it is directed toward the lower side, the heat exchange at the lower side of the reactor 100 is promoted, and the heat exchange can be performed in a balanced manner in the reactor 100 all over in the up-down direction. Note that a plurality of the communication holes 24 are provided at a plurality of locations (two locations in the illustrated example) in the circumferential direction.

As illustrated in FIGS. 1 and 2, in the lower piece 100B of the reactor 100, further, a downward flow passage 50 in which the fuel after reforming (reformed fuel) flows is formed above the heat carrier flow passage 20. In other words, the downward flow passage 50 is also formed in a helical or spiral shape centered on the vertical axis C, and is alternately arranged with the reaction flow passage 10 in the radial direction.

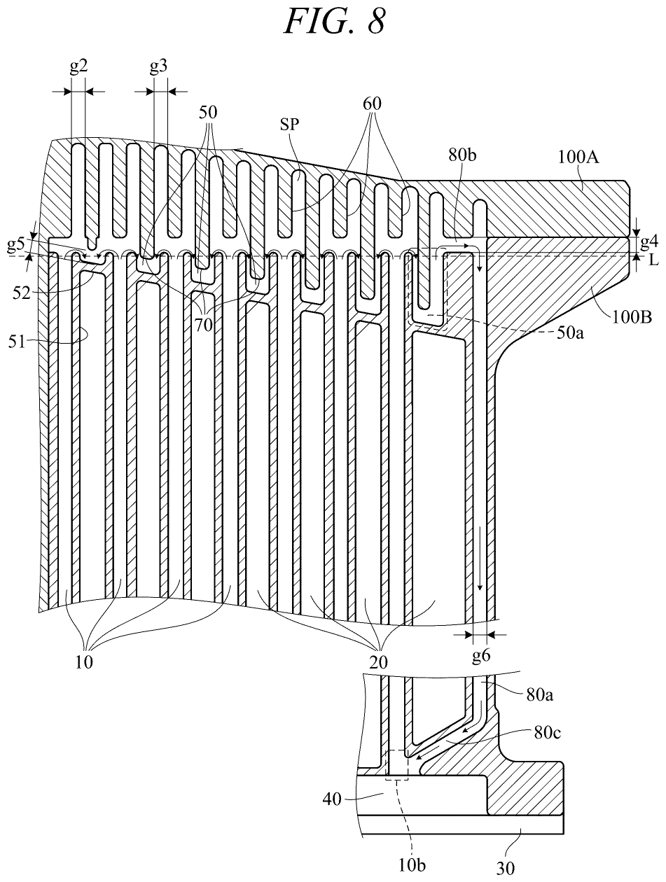

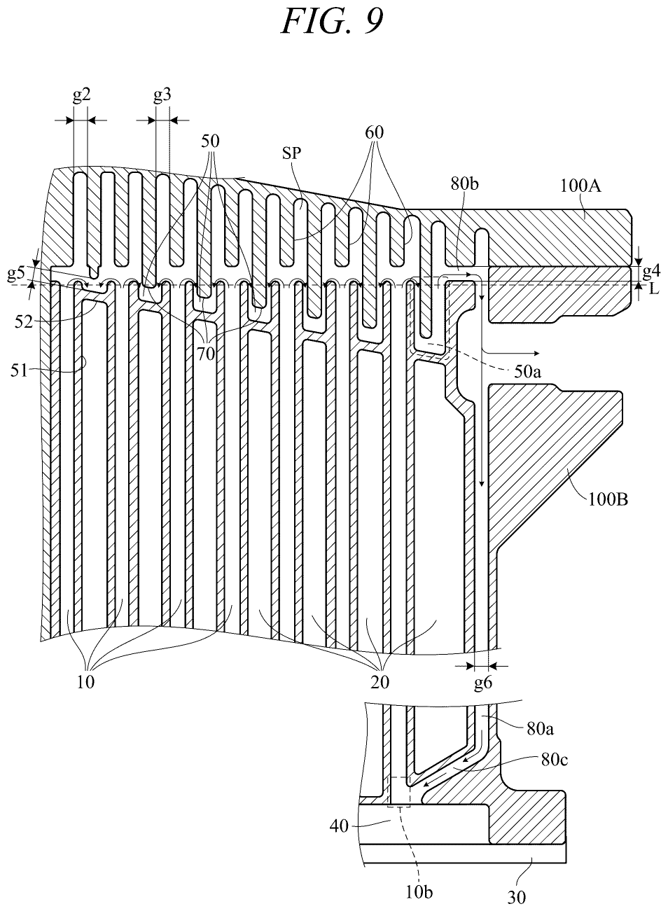

FIG. 8 is a cross-sectional view of the reactor 100 taken along line VIII-VIII in FIG. 1, and FIG. 9 is a cross-sectional view of the reactor 100 taken along line IX-IX in FIG. 1. As illustrated in FIGS. 1, 2, 8, and 9, an upper end surface of the downward flow passage 50 is open to communicate with an upper end surface of the reaction flow passage 10. A height of the upper end surface of the reaction flow passage 10 and a height of the upper end surface of the downward flow passage 50 are the same as a height of a partition wall 51 separating the reaction flow passage 10 and the downward flow passage 50 (and the heat carrier flow passage 20), and are the same as each other all over in the radial direction. The heat carrier flow passage 20 and the downward flow passage 50 are separated by a partition wall 52, and a height of the upper end surface of the heat carrier flow passage 20, a height of a lower end surface of the downward flow passage 50, and a height of the partition wall 52 are substantially the same as each other all over in the radial direction. The lower end surface of the downward flow passage 50 is positioned above the lower end surfaces of the reaction flow passage 10 and the heat carrier flow passage 20 all over in the radial direction, and is formed to be inclined downward toward a radial outer side.

The upper piece 100A of the reactor 100 has a first projecting portion 60 and a second projecting portion 70 formed to project downward from an inner wall surface on an upper side of the upper piece. The first projecting portion 60 is formed corresponding to the reaction flow passage 10 and projects from the inner wall surface above the reaction flow passage 10 toward the reaction flow passage 10 all over in the radial direction. The second projecting portion 70 is formed corresponding to the downward flow passage 50 (and the heat carrier flow passage 20) and projects from the inner wall surface above the downward flow passage 50 toward the downward flow passage 50 all over in the radial direction.

As illustrated in FIGS. 8 and 9, a gap g2 between the first projecting portion 60 and the second projecting portion 70, more specifically, between an outer end surface of the first projecting portion 60 and an inner end surface of the second projecting portion 70 in the radial direction, is also formed to be equal to or smaller than twice the quenching distance or equal to or smaller than the maximum safety gap. Similarly, a gap g3 between an outer end surface of the second projecting portion 70 and an inner end surface of the first projecting portion 60 is also formed to be equal to or smaller than twice the quenching distance or equal to or smaller than the maximum safety gap. Furthermore, a gap g4 between the upper end surface of the reaction flow passage 10 and a lower end surface of the first projecting portion 60 and a gap g5 between the lower end surface of the downward flow passage 50 and a lower end surface of the second projecting portion 70 are also formed to be equal to or smaller than twice the quenching distance or equal to or smaller than the maximum safety gap.

A liquid level (gas-liquid separation surface) L of the reformed fuel is adjusted to be located between the upper end surface of the reaction flow passage 10 and the downward flow passage 50 and the lower end surface of the first projecting portion 60. A space (gas-liquid separation space) SP from the gas-liquid separation surface L to the inner wall surface on the upper side of the upper piece 100A has a helical or spiral labyrinth shape due to the first projecting portion 60 and the second projecting portion 70. Consequently, sufficient gas-liquid separation can be performed in the gas-liquid separation space SP. Therefore, it is not necessary to separately provide a gas-liquid separating device such as a separator or a condenser, and the entire configuration of the reactor 100 can be simplified. By dividing the reactor 100 into the upper piece 100A and the lower piece 100B, it is possible to form an internal shape in which upper end portions of the partition walls 51 and 52 and the lower end portions of the first projecting portion 60 and the second projecting portion 70 are intricately positioned.

As illustrated in FIGS. 1 and 2, in the upper piece 100A of the reactor 100, further a gas discharging flow passage 53 for discharging the gas from the reaction flow passage 10 is formed. The gas discharging flow passage 53 communicates with the reaction flow passage 10 via the gas-liquid separation space SP. The air supplied to the reaction flow passage 10 via the opening 31 of the closing plate 30 rises in the reaction flow passage 10 to be subjected to the reforming reaction, is then released from the gas-liquid separation surface L into the gas-liquid separation space SP, and is discharged to the external space via the gas discharging flow passage 53 after the liquid is separated in the gas-liquid separation space SP. The air discharged via the gas discharging flow passage 53 is supplied to an intake port of the engine and sucked into a combustion chamber of the engine together with fresh air.

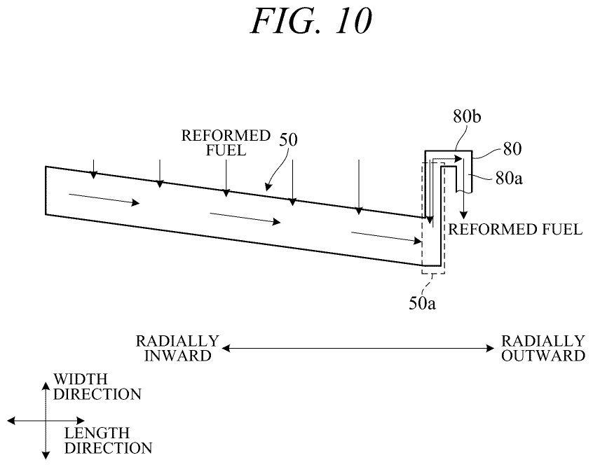

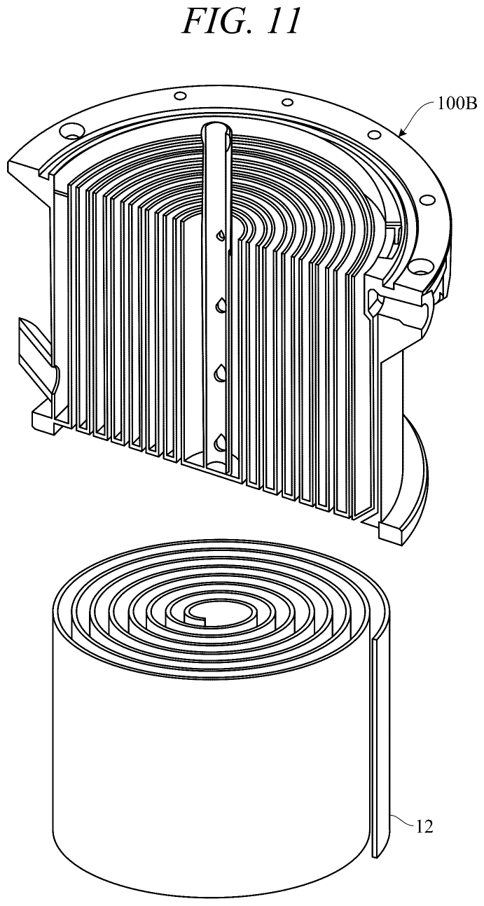

FIG. 10 is a view for describing the downward flow passage 50. As illustrated in FIGS. 1, 2, and 8 to 10, the lower end surface of the downward flow passage 50 is formed to be inclined downward toward the radial outer side. As illustrated in FIGS. 1 to 3 and 8 to 10, in the lower piece 100B of the reactor 100, further, a return flow passage 80 for allowing the reformed fuel to be returned to a returning flow portion 10b (FIG. 4) provided at the lower end of the maximum outer diameter portion of the reaction flow passage 10 is formed. As illustrated in FIGS. 8 and 9, a gap g6 between inner wall surfaces of the return flow passage 80, more specifically, between an inner end surface and an outer end surface of the return flow passage 80 in the radial direction, is also formed to be equal to or smaller than twice the quenching distance or equal to or smaller than the maximum safety gap.

As illustrated in FIGS. 2, 3, and 8 to 10, the return flow passage 80 includes a vertical flow passage 80a, a horizontal flow passage 80b, and an inclined flow passage 80c. The vertical flow passage 80a extends in a vertical direction from the vicinity of an upper end to the vicinity of a lower end of the lower piece 100B on a side further outward from the maximum outer diameter portions of the reaction flow passage 10 and the heat carrier flow passage 20, that is, the maximum outer diameter portion of the partition walls 51. The horizontal flow passage 80b extends in the horizontal direction on the upper end surface of the maximum outer diameter portion of the partition wall 51 to allow a returning flow portion 50a provided at the maximum outer diameter portion of the downward flow passage 50 to communicate with an upper end surface of the vertical flow passage 80a. The inclined flow passage 80c extends to be inclined downward toward the radial inner side to allow a lower end of the vertical flow passage 80a to communicate with the returning flow portion 10b provided at the lower end of the maximum outer diameter portion of the reaction flow passage 10. In other words, a lower end surface of the return flow passage 80 is formed to be inclined downward toward the radial inner side.

As illustrated in FIGS. 1 and 9, in the lower piece 100B of the reactor 100, further, a reaction liquid discharging flow passage 90 for discharging a part of the reformed fuel from the returning flow portion 50a of the downward flow passage 50 is formed. The reaction liquid discharging flow passage 90 extends in the horizontal direction near an upper end of the return flow passage 80, more specifically, at a position slightly lower than the horizontal flow passage 80b, to allow the vertical flow passage 80a to communicate with the external space.

As illustrated in FIGS. 5 and 8 to 10, the reformed fuel which is reformed while flowing upward in the width direction of the reaction flow passage 10 overflows from the upper end surface of the reaction flow passage 10, flows into the downward flow passage 50 beyond the partition walls 51, and flows radially outward in the length direction of the downward flow passage 50. Since the lower end surface of the downward flow passage 50 is formed to be inclined downward toward the radial outer side, the flow of the reformed fuel toward the radial outer side is promoted, and the reformed fuel can be smoothly circulated.

A part of the reformed fuel that has reached the maximum outer diameter portion (the returning flow portion 50a) of the downward flow passage 50 is discharged via the reaction liquid discharging flow passage 90, and the rest thereof is returned to the lower end (the returning flow portion 10b) of the maximum outer diameter portion of the reaction flow passage 10 via the return flow passage 80. Even in a case where the fuel contains a catalyst, catalyst particles are not discharged from the reaction liquid discharging flow passage 90 in the horizontal direction, but are returned to the reaction flow passage 10 together with the reformed fuel via the return flow passage 80 (the vertical flow passage 80a). Since the lower end surface of the return flow passage 80 is formed to be inclined downward toward the radial inner side, the flow of the reformed fuel toward the radial inner side is promoted, and the reformed fuel can be uniformly circulated in the reaction flow passage 10 all over in the radial direction.

When the reactor 100 is configured as described above, it is possible to efficiently increase the volume of the reaction flow passage 10 which is the reaction field while ensuring the safety of the reactor 100, and it is possible to decrease the entire reactor 100 in size. Hence, it is possible to improve mountability on a vehicle. Furthermore, the band-shaped reaction flow passage 10 which is the reaction field is sandwiched by the similar band-shaped heat carrier flow passages 20, and the temperature is efficiently increased over the entire region. Therefore, the contact reforming reaction can proceed efficiently even in a case where relatively low-temperature engine cooling water is used as the heat carrier.

Furthermore, by returning the reformed fuel into the reactor 100 and recirculating the reformed fuel in the reaction flow passage 10, a reaction rate (reforming rate) can be improved even in certain reaction conditions (the atmospheric pressure and the engine water temperature). In other words, as the reformed fuel is repeatedly circulated in the reaction flow passage 10, a substantial reaction time is lengthened, and the reaction rate is improved. In particular, by uniformly forming a height of the reaction flow passage 10, the reformed fuel can uniformly overflow all over in the radial direction and in the length direction of the reaction flow passage 10 and the downward flow passage 50, and the reformed fuel can efficiently return. Further, when the reaction liquid supplying flow passage 11 and the return flow passage 80 extend in the vertical direction and are formed so that the lower end surface is inclined downward toward the radial inner side, the flow toward the radial inner side can be promoted, and the reformed fuel can efficiently return.

According to this embodiment, the following operations and effects can be achieved.

(1) The reactor 100 includes the reaction flow passage 10 that is formed in the band shape to extend in the length direction and the width direction and is formed in a helical or spiral shape centered on a vertical axis C parallel to the width direction and has an open upper end surface, the downward flow passage 50 that is formed in a helical or spiral shape centered on the vertical axis C to be radially arranged alternately with the reaction flow passage 10 on a vertical cross section including the vertical axis C and has an open upper end surface to communicate with the upper end surface of the reaction flow passage 10, the reaction liquid supplying flow passage 11 through which unreformed fuel is supplied to the supplying portion 10a provided at the lower end of a maximum outer diameter portion of the reaction flow passage 10 centered on the vertical axis C, the reaction liquid discharging flow passage 90 through which the reformed fuel is discharged from the returning flow portion 50a provided at the maximum outer diameter portion of the downward flow passage 50 centered on the vertical axis C, and the return flow passage 80 that allows the returning flow portion 10b provided at the lower end of the maximum outer diameter portion of the reaction flow passage 10 to communicate with the returning flow portion 50a provided at the maximum outer diameter portion of the downward flow passage 50 (FIGS. 1 to 5 and 8 to 10).

The height of the upper end surface of the reaction flow passage 10 and the height of the upper end surface of the downward flow passage 50 are substantially the same as each other all over in the radial direction centered on the vertical axis C (FIGS. 1, 2, 8, and 9). The lower end surface of the downward flow passage 50 is positioned above the lower end surface of the reaction flow passage 10 all over in the radial direction and is formed to be inclined downward toward the radial outer side centered on the vertical axis C (FIGS. 1, 2, 8, and 9).

As described above, by making the reactor 100 in the helical or spiral shape, the volume of the reaction field can be efficiently increased. Furthermore, the reaction rate (the reforming rate) can be improved by recirculating the reaction liquid (fuel) in the reactor 100. In other words, the reaction liquid supplied from the lower end of the maximum outer diameter portion of the reaction flow passage 10 via the reaction liquid supplying flow passage 11 circulates radially inward in the length direction, circulates from below to above in the width direction, and overflows from the upper end surface of the reaction flow passage 10 to flow into the downward flow passage 50. The reaction liquid flowing into the downward flow passage 50 circulates radially outward in the length direction, and when the reaction liquid reaches the maximum outer diameter portion, a part thereof is discharged via the reaction liquid discharging flow passage 90, and the rest thereof is returned to the reaction flow passage 10 via the return flow passage 80 to be recirculated.

(2) The height of the upper end surface of the reaction flow passage 10 is uniform all over in the radial direction (FIGS. 1, 2, 5, 8, and 9). Consequently, it is possible to cause the reaction liquid to uniformly overflow all over in the radial direction of the reaction flow passage 10 and to be efficiently circulated.

(3) The lower end surface of the reaction liquid supplying flow passage 11 and the lower end surface of the return flow passage 80 are formed to be inclined downward toward the radial inner side centered on the vertical axis C (FIGS. 1, 2, 5, and 9). Consequently, the flow of the reaction liquid toward the center is promoted, and the reaction liquid can be uniformly circulated in the reaction flow passage 10 all over in the radial direction.

(4) The reactor 100 further includes, below the downward flow passage 50, a heat carrier flow passage 20 formed in a helical or spiral shape centered on the vertical axis C to be alternately arranged in the radial direction with the reaction flow passage 10 in the vertical cross section, the heat carrier supplying flow passage 21 through which the heat carrier is supplied to the maximum outer diameter portion of the heat carrier flow passage 20 centered on the vertical axis C, and the heat carrier discharging flow passage 22 through which the heat carrier is discharged from the central portion of the heat carrier flow passage 20 centered on the vertical axis C (FIGS. 1 to 3, 6, 8, and 9). Consequently, the reaction flow passage 10 through which the reaction liquid flows is sandwiched by the heat carrier flow passage 20 through which the heat carrier flows, and the temperature is efficiently raised over the entire region, so that the reaction can efficiently proceed even in a case where a relatively low temperature heat carrier such as the engine cooling water is used.

(5) The reactor 100 further includes the closing plate 30 having the opening 31 for supplying gas from the lower end of the reaction flow passage 10 all over in the radial direction (FIGS. 1, 2, and 5). Consequently, it is possible to efficiently supply the necessary gas (air) to the entire region of the reaction flow passage 10 which is the reaction field of the gas-liquid reaction (reforming reaction) and to improve the reaction rate. Furthermore, the upward flow of the reaction liquid is promoted by the upward flow of the gas, and the reaction liquid can be efficiently circulated.

(6) The reactor 100 further includes the first projecting portion 60 that projects downward from above the reaction flow passage 10 toward the reaction flow passage 10 all over in the radial direction, and the second projecting portion 70 that projects downward from above the downward flow passage 50 toward the downward flow passage 50 all over in the radial direction (FIGS. 1, 2, 8, and 9).

(7) The gap g1 between the inner end surface and the outer end surface of the reaction flow passage 10, the gap g2 between the outer end surface of the first projecting portion 60 and the inner end surface of the second projecting portion 70, and the gap g3 between the outer end surface of the second projecting portion 70 and the inner end surface of the first projecting portion 60 in the radial direction centered on the vertical axis C are equal to or smaller than twice the quenching distance or equal to or smaller than the maximum safety gap (FIGS. 8 and 9). The gap g4 between the upper end surface of the reaction flow passage 10 and the lower end surface of the first projecting portion 60 and the gap g5 between the lower end surface of the downward flow passage 50 and the lower end surface of the second projecting portion 70 are also formed to be equal to or smaller than twice the quenching distance or equal to or smaller than the maximum safety gap (FIGS. 8 and 9). Consequently, the volume of the reaction field can be efficiently increased while the safety of the reactor 100 is ensured.

(8) The reactor 100 further includes the closing plate 30 having the opening 31 through which the gas from the lower end of the reaction flow passage 10 is supplied all over in the radial direction, and the gas discharging flow passage 53 through which the gas from the reaction flow passage 10 is discharged (FIGS. 1 and 2). The gas discharging flow passage 53 communicates with the reaction flow passage 10 via the gas-liquid separation space SP demarcated by the first projecting portion 60, the second projecting portion 70, and the upper end surfaces of the reaction flow passage 10 and the downward flow passage 50 (FIGS. 1, 2, 8, and 9). Consequently, the sufficient gas-liquid separation can be performed in the gas-liquid separation space SP above the reaction flow passage 10 and the downward flow passage 50, so that it is not necessary to separately provide a gas-liquid separating device such as a separator or a condenser, and the entire configuration of the reactor 100 can be simplified.

(9) The reactor 100 includes the lower piece 100B in which the reaction flow passage 10, the downward flow passage 50, the reaction liquid supplying flow passage 11, the reaction liquid discharging flow passage 90, and the return flow passage 80 are formed, and the upper piece 100A in which the first projecting portion 60 and the second projecting portion 70 are formed (FIGS. 1, 2, 8, and 9). The lower piece 100B and the upper piece 100A are configured to be detachably attached to each other (FIG. 1). Consequently, maintainability of the inside of the reactor 100 is improved.

(10) The reaction liquid is a fuel containing hydrocarbons as a main component, the gas is air, and the reaction flow passage 10 is configured such that the oxidation reaction of the fuel supplied via the reaction liquid supplying flow passage 11 is performed in the presence of the catalyst. For example, the reactor 100 is configured as a reforming reactor that is mounted on a vehicle and reforms in-vehicle fuel. By efficiently increasing the volume of the reaction field in the reactor 100 described above, mountability thereof on a vehicle can be improved.

The above embodiments can be modified into various modification examples. Hereinafter, some modification examples will be described. In the above embodiments, the example has been described in which the catalyst is provided in the reaction flow passage 10, but as illustrated in FIG. 11, a catalyst obtained by supporting a catalyst on a carrier 12 which can be inserted into and removed from the reaction flow passage 10 may be used. As the carrier 12, a material having a large non-surface area such as a porous body can be used. In the case where the catalyst is provided in the reaction flow passage 10, the catalyst may be added or replaced depending on the state of aging or the like. Since the reactor 100 is configured to be dividable into the upper piece 100A and the lower piece 100B, and the catalyst is used by being supported on the carrier 12 that can be inserted into and removed from the reaction flow passage 10, maintainability of the reactor 100 can be further improved.

In the above embodiments, the example has been described in which the fuel applied to an in-vehicle compression ignition engine and supplied from the fuel tank to the engine reacts with oxygen in the air at an elevated temperature to be reformed, but the reactor is not limited thereto as long as a liquid is circulated and reacts. The presence or absence of the catalyst applied to a first flow passage, a type of catalyst, a plating treatment on an inner wall surface of the first flow passage, and the like can be appropriately selected depending on a type of chemical reaction to which the reactor is applied. When the reactor is applied to a reaction proceeding at room temperature, a third flow passage, the heat carrier supplying flow passage through which the heat carrier is supplied to the third flow passage, and the heat carrier discharging flow passage through which the heat carrier is discharged from the third flow passage can be omitted. In a case where the reactor is applied to a reaction not involving gas, the gas supplying flow passage can be omitted. In this case, the lower end surface of the first flow passage may be closed.

The above embodiment can be combined as desired with one or more of the aforesaid modifications. The modifications can also be combined with one another.

According to the present invention, it becomes possible to efficiently increase the volume of the reaction field.

Above, while the present invention has been described with reference to the preferred embodiments thereof, it will be understood, by those skilled in the art, that various changes and modifications may be made thereto without departing from the scope of the appended claims.

1. A reactor, comprising:
a first flow passage formed in a band shape to extend in a length direction and a width direction and formed in a spiral shape centered on a vertical axis parallel to the width direction and having an open upper end surface;
a second flow passage formed in a spiral shape centered on the vertical axis to be radially arranged alternately with the first flow passage on a vertical cross section including the vertical axis and having an open upper end surface to communicate with the upper end surface of the first flow passage;
a reaction liquid supplying flow passage through which reaction liquid is supplied to a supplying portion provided at a lower end of a maximum outer diameter portion of the first flow passage centered on the vertical axis;
a reaction liquid discharging flow passage through which the reaction liquid is discharged from a discharging portion provided at a maximum outer diameter portion of the second flow passage centered on the vertical axis; and
a return flow passage connecting a first connecting portion provided at the lower end of the maximum outer diameter portion of the first flow passage and a second connecting portion provided at the maximum outer diameter portion of the second flow passage, wherein
a height of the upper end surface of the first flow passage and a height of the upper end surface of the second flow passage are substantially same as each other all over in a radial direction centered on the vertical axis, wherein
a lower end surface of the second flow passage is positioned above a lower end surface of the first flow passage all over in the radial direction and is formed to be inclined downward toward a radial outer side centered on the vertical axis.

2. The reactor according to claim 1, wherein
the height of the upper end surface of the first flow passage is uniform all over in the radial direction.

3. The reactor according to claim 1, wherein
a lower end surface of the reaction liquid supplying flow passage and a lower end surface of the return flow passage are formed to be inclined downward toward a radial inner side centered on the vertical axis.

4. The reactor according to claim 1, further comprising:
a third flow passage formed in a spiral shape centered on the vertical axis to be radially arranged alternately with the first flow passage on the vertical cross section below the second flow passage;
a heat carrier supplying flow passage through which heat carrier is supplied to a maximum outer diameter portion of the third flow passage centered on the vertical axis; and
a heat carrier discharging flow passage through which the heat carrier is discharged from a central portion of the third flow passage centered on the vertical axis.

5. The reactor according to claim 1, further comprising:
a gas supplying flow passage through which gas is supplied from a lower end of the first flow passage all over in the radial direction.

6. The reactor according to claim 1, further comprising:
a first projecting portion projecting downward from above the first flow passage toward the first flow passage all over in the radial direction; and
a second projecting portion projecting downward from above the second flow passage toward the second flow passage all over in the radial direction.

7. The reactor according to claim 6, wherein
a gap between an inner end surface and an outer end surface of the first flow passage in the radial direction is equal to or smaller than twice a quenching distance or equal to or smaller than a maximum safety gap, wherein
a gap between an outer end surface of the first projecting portion and an inner end surface of the second projecting portion in the radial direction is equal to or smaller than twice the quenching distance or equal to or smaller than the maximum safety gap, wherein
a gap between an outer end surface of the second projecting portion and an inner end surface of the first projecting portion in the radial direction is equal to or smaller than twice the quenching distance or equal to or smaller than the maximum safety gap, wherein
a gap between the upper end surface of the first flow passage and a lower end surface of the first projecting portion is equal to or smaller than twice the quenching distance or equal to or smaller than the maximum safety gap, wherein
a gap between the lower end surface of the second flow passage and a lower end surface of the second projecting portion is equal to or smaller than twice the quenching distance or equal to or smaller than the maximum safety gap.

8. The reactor according to claim 6, further comprising:
a gas supplying flow passage through which gas is supplied from a lower end of the first flow passage all over in the radial direction; and
a gas discharging flow passage through which the gas is discharged from the first flow passage, wherein
the gas discharging flow passage is connected to the first flow passage through a gas-liquid separation space demarcated by the first projecting portion, the second projecting portion, the upper end surface of the first flow passage, and the upper end surface of the second flow passage.

9. The reactor according to claim 6, further comprising:
a lower piece in which the first flow passage, the second flow passage, the reaction liquid supplying flow passage, the reaction liquid discharging flow passage, and the return flow passage are formed; and
an upper piece in which the first projecting portion and the second projecting portion are formed, wherein
the lower piece and the upper piece are configured to be detachably attached to each other.

10. The reactor according to claim 5, wherein
the reaction liquid is fuel containing hydrocarbons as a main component, wherein
the gas is air, wherein
the first flow passage is configured such that the fuel supplied through the reaction liquid supplying flow passage is oxidized in presence of a catalyst.

11. The reactor according to claim 1, wherein
a gap between an inner end surface and an outer end surface of the first flow passage in the radial direction is equal to or smaller than twice a quenching distance or equal to or smaller than a maximum safety gap.
